(19) United States
(12) Patent Application Publication
(10) Pub. No.: US 2006/0288645 A1
(43) Pub. Date: Dec. 28, 2006

(54) Method and apparatus for selective solar control

(75) Inventors: Eitan Konstantino, Orinda, CA (US); Moshe Konstantin, Highland Park, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: CPI INTERNATIONAL INC., Lake Forest, IL (US)

(21) Appl. No.: 11/450,504

(22) Filed: Jun. 9, 2006

Related U.S. Application Data
(60) Provisional application No. 60/689,176, filed on Jun. 10, 2005.

(51) Int. Cl. E06B 7/08

(52) U.S. Cl. 49/92.1

(57) ABSTRACT

This invention is a system of transparent or translucent panel units that permit selective transmission of light and solar radiation or glare across the system and can be adjusted and controlled according to a user's varying needs using light-controlling members mounted for rotation about their longitudinal axes. The system can illuminate the interior space by reflected sunlight, conducting both light from the brightest part of the sky and low-angle sunlight efficiently into the interior space, and also shading or deflecting the intense light found when the sun is at high elevation. Alternatively, the amount of a selected portion of the radiation spectrum passed through the system can be set at will, and can be amplified to allow increased light passage and transmission.

### CROSS REFERENCE TO RELATED APPLICATION

This patent application claims the benefit of U.S. Provisional Serial Application No. 60/689,176, filed Jun. 10, 2005, which is hereby incorporated by reference in its entirety.

### FIELD OF THE INVENTION

This invention relates to architectural structures designed to pass light and, more particularly, to transparent/translucent panel systems for harvesting the sun and controlling the level of light, spectral performance and solar or optical radiation admitted or deflected through sloped, vertical, and horizontal glazing, skylights, roofs, walls, and other architectural structures designed to pass light. This invention also relates to improved support systems for improving the reliability of such systems.

### BACKGROUND OF THE INVENTION

Various types of transparent and translucent glazing systems are available for the construction of sloped, vertical, and horizontal glazing, skylights, roofs, walls, and other architectural structures designed to pass light for daylighting interiors and other purposes. When using such glazing systems, it is often desirable to optimize the system's solar (or optical) transmission performance by selectively transmitting, reflecting or otherwise selectively blocking the solar radiation spectrum. Reducing solar heat gain on hot summer days and/or increasing solar heat gain on cold winter days, while providing the correct light level and harvesting the sun when it is most needed is highly desirable. It is also often desirable to pass more light when the sun is low in the sky or deliver light and controlled solar radiation for an extended period of the day. A glazing system that harvests sunlight all year around and deflects the solar radiation spectrum as needed, can contribute to improved environmentally friendly building construction.

Indeed, if the level of light and solar radiation passing through sloped, vertical, and horizontal glazing, skylights, roofs, walls, and other architectural structures designed to pass light can be simply and efficiently controlled, it will enable architects and space planners to design more energy efficient buildings and comfortable spaces. If support systems were available to insure the reliability of architectural structures designed to provide such control, architects and space planners would embrace such structures.

The known approaches to controlling the amount of solar radiation admitted through glazing panel systems, however, are limited, are generally difficult or expensive to construct and service, and are often unable to accommodate excessive positive or negative loading. There is therefore a substantial need for a flexible, inexpensive, reliable and readily serviceable system for achieving this purpose, which also provides an economical solution for long and/or large glazed areas.

Prior approaches to controlling the level of solar radiation passing through architectural structures have been of only limited usefulness. For example, louver blind assemblies using pivoting flexible members operable inside a chamber formed by a double-glazed window unit have been suggested for this purpose. Such louver blinds require substantial support of the flexible members which, additionally, must be controlled from both their distal and their proximal ends. Furthermore, louver blinds are difficult and expensive to assemble, apply, operate, maintain and replace, and cannot be readily adapted for use in non-vertical applications, large glazed roofing areas or in applications in which it is either desirable or necessary to control the flexible members from only one end.

U.S. Pat. No. 6,499,255 provides another, more recent approach to addressing this challenge. The '255 patent describes a unitary transparent or translucent panel of controllable radiation transmissivity comprising a plurality of rotatably-mounted radiation-blocking tubular members having at least one portion that is substantially opaque and means for rotating the radiation-blocking members to block out varying amounts of the radiation striking the panel by varying the area of the opaque portions presented to the incoming light. It is key to this structure that each of the radiation-blocking members be substantially opaque so as to substantially block the passage of radiation including not only the spectral range of solar radiation or visible light, but also ranges of electromagnetic radiation below and above the spectral range of visible light.

While the unitary panel described in the '255 patent represents an advance in the art, it has some shortcomings. For example, one of the limitations of the '255 patent is the limited range of solar radiation manipulation and deflection that it provides. There is no ability to selectively transmit or otherwise selectively block or reflect portions of the spectrum or to deflect direct solar radiation while passing diffused light to improve daylighting benefits in the system of the '255 patent. For example, a limitation that results from manipulating the solar radiation as a single undivided source is the inability to allow the infrared portion of the solar spectrum (700-2800 nm) to pass while blocking the passage of visible light and/or UV radiation, or any other spectral combinations thereof. Another limitation is the inability to allow UV transmission when required, for example, for animal habitats, solaria, and enclosures for photodegradable waste or zoo applications.

A growing demand for designing sustainable construction (“green construction”) requires new innovative approaches to daylighting applications. A system that could meet this demand would transmit daylight into an interior space, while allowing for the reflectance of light from the interior space back into the interior space. Furthermore, a system that could reflect the desired level of interior artificial light back into the interior of a structure while controlling the level of incoming outside light and radiation would be very welcome. Finally, such a system that senses the interior light level and balances the level of incoming light and radiation and reflected artificial light to maintain a predetermined level of interior illumination would be a very important contribution to the art. The present invention makes this possible, particularly with the use of rotatable retro-reflective members and surfaces. For example, such advanced performance is an ideal solution for classrooms that consume substantial energy on a regular daily basis during daylight hours. The panels described in the '255 patent do not provide an optimal solution to these challenges.

Another limitation of '255 patent panel system is that the opaque surfaces of the radiation-blocking members cannot efficiently deflect direct solar radiation while transmitting diffuse light as desired. Rather, radiation-blocking opaque surfaces absorb most of the solar radiation entering the panel, emitting part of this energy as heat into the interior space. This can produce undesirable and uncontrollable performance on hot summer days. In addition, such radiation blocking members are unable to light interiors with diffuse light thereby avoiding glare and other objectionable lighting effects.

Yet another limitation of the panel system of the '255 patent is that the maximum amount of light passing through the system is limited to a range of about 5% up to 58%. This is because the light transmission is limited by both the panel material and the opaque surfaces of the radiation blocking members inside the panels. In wintertime, on cloudy days or when sunlight is insufficient, the ability of current systems such as that of the '255 patent to transport additional illumination or to harvest the sun by reflective and/or deflective techniques is unduly limited.

Some efforts have been made to design systems that will increase natural light illumination by reflecting the sunlight into interior spaces. One example is the “Solar Tube” by Nulite (CA) or the “Sun Tunnel” by Velux. These tubular light systems are installed on a roof and can provide reflected natural light illumination greater then the amount of transmitted light that would pass through an opening of the same size. Another approach is the reflective “LightLouver” (by LightLouver LLC) which offers a passive optics solution for windows. These systems are not controllable and do not have moving parts. They are also limited in size and would not provide sufficient illumination to large openings in commercial buildings or a solution for a controllable glazing panel.

U.S. Pat. Nos. 6,433,932 and 6,493,145 provide another approach. These patents describe suspended mirror assemblies installed under small plastic domes to track the sun and reflect light inside an interior space. These systems are complicated and do not offer an economic solution for glazing panels system or for long and large glazed areas.

U.S. Patent No. 6,858,306 provides a selective technology approach involving coating architectural glass to provide specific energy absorption and light transmission or spectral properties. This approach is limited to glass and it does offer the ability to adjust, change or control the spectral properties or selectivity to meet varying user requirements with the changing of seasons.

A more recent patent issued to the assignee of the '255 patent, U.S. Pat. No. 6,978,578, describes a panel unit of controllable radiation transmissivity including rotatable radiation-blocking members disposed between front and rear panels. The panel units of this patent utilize unitary lower and upper cross members with guiding surfaces for the radiation-blocking members. These cross members must be disposed inside of and extend across the unit housings which include the front and rear panels. These members take up scarce space in the panel units and therefore must be so small that they cannot significantly stiffen the units to improve their resistance to loads. As a result, the housings do not effectively protect the operation of the radiation-blocking members from interference or damage resulting from flexure of the top panels due to excessive positive or negative loading.

### BRIEF SUMMARY OF THE INVENTION

It is one objective of this invention to provide a system comprising transparent or translucent panel units or independent panels, fitted with selective solar control surfaces, that permit selective transmission of light, solar radiation or glare across the system, and can be adjusted and controlled according to a user's specific needs all year around. In some cases the system illuminates the interior space by reflected sunlight, conducting both light from the brightest part of the sky and low-angle sunlight efficiently into the interior space, and also shading or deflecting the intense light found when the sun is at a high elevation. In one embodiment, the amount of a selected portion of the radiation spectrum passed through the system can be set at will, and can be amplified to allow increased light passage and transmission when compared to similarly sized systems. This may be accomplished with a series of light-controlling members mounted for rotation about their longitudinal axes and disposed inside twin-wall glazing panels, between independent pairs of glazing panels, or below single glazing panels.

The light controlling members will have at least one substantially solar-controlling portion enabling the glazing panel to adjust the light or control the solar radiation and spectral transmission passing or deflected through a glazing panel.

In one preferred embodiment of the invention, once installed, the light-controlling members as well as other components housed between the panels can be readily accessed by removing one of the two panels, leaving the second panel in place to protect areas enclosed by the panel system from exposure to the outside environment.

In other preferred embodiments, support systems are provided for the light-controlling members that enable the system to withstand excessive positive and negative loading. These support systems comprise cross members that extend across the front panels of panel units—cross members extending across the rear panels are not required.

The selective solar systems of the present invention thus can continuously control and reliably maintain a desired balance between light transmission and solar performance, fostering a daylighted, comforting, livable, productive and energy efficient environment in interior spaces all year round. The systems may be fully automatic, with built-in intelligent light controllers and control systems that sense the daylight outside and manage the level of light and solar heat gain inside based on the level of sunlight outside. Thus, by simply setting desired spectral levels, users are able to control natural daylight and comfort levels in any space all day long, and all year around.

### BRIEF DESCRIPTION OF THE DRAWINGS

The features of this invention that are believed to be novel are set forth with particularity in the appended claims. The invention, together with its objects and advantages, may be best understood by reference to the following description, taken in conjunction with the following drawings, in which like reference numerals identify like elements in the several figures, and in which:

FIG. 1 is a front elevation view of a portion of a prior art panel in accordance with the teaching of U.S. Pat. No. 6,499,255;

FIG. 2 and FIG. 2A are front elevation views of panel units in accordance with the present invention, attached to adjacent panel units which are shown in part;

FIG. 2B is a partial front elevation view of another panel unit in accordance with the present invention;

FIG. 3 is a series of cross-sectional views of light-controlling members having solar-controlling portions of varying geometries;

FIG. 4 illustrates a series of hemispherical light-controlling members having varying solar-controlling surfaces in accordance with the invention;

FIG. 5 contains a series of solar-controlling portions of varying geometries;

FIG. 6 shows light-controlling members in accordance with the present invention where the selective solar control member is carried by annular members or rings;

FIG. 7 depicts a micro-prismatic toothed surface;

FIG. 8 illustrates a panel system unit comprising a series of adjacent cells containing light-controlling members fitted with solar controlling members;

FIG. 8A illustrates a series of panel units in accordance with the present invention assembled to produce a panel system for use in a skylight;

FIGS. 9A-9G are diagrammatic representations of solar controlling portions using the principles of retro-reflectivity;

FIGS. 10A-10C illustrate extruded panels containing light-controlling members where the upper surface of the extruded panels are coated or structured to achieve specific light-controlling objectives; and

FIG. 11 is a graph of solar radiation transmission of a plastic material having selective solar radiation transmittance may be used in the present invention.

### DETAILED DESCRIPTION OF THE INVENTION

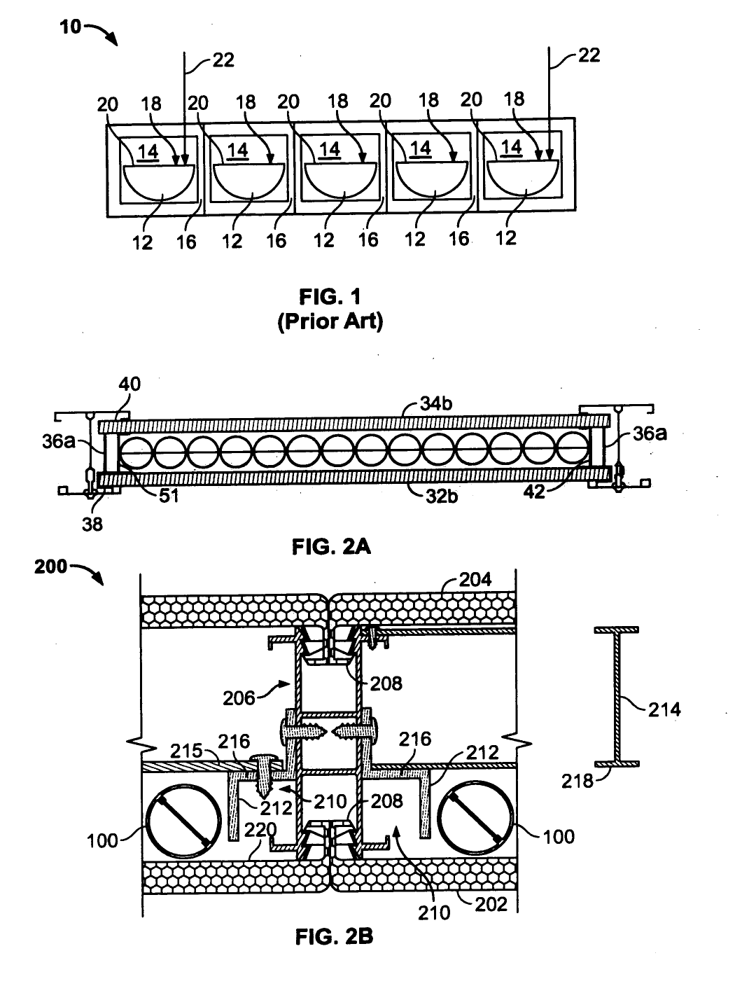

Turning first to FIG. 1, an elevational view of a transparent or translucent panel 10 in accordance with the teaching of prior U.S. Pat. No. 6,499,255 is shown. Panel 10 includes a series of half-cylinder louvers 12 rotatably mounted in a series of adjacent, segregated cells 14 separated by walls 16. Louvers 18 each have an opaque top surface 20. Thus, in the illustrated embodiment where the louvers are in the fully closed position, light rays 22 strike opaque surfaces 20, which block light transmission through the opaque louvers and the panel. The opaque top surface blocks the light/solar spectral radiation and therefore absorbs the solar radiation rather then reflecting or deflecting it. Additionally a portion of the absorbed solar radiation is emitted as heat into the interior space below the panel. The lack of selective solar reflection or deflection properties as well as the inability to selectively transmit or block the solar spectrum creates undesirable glare and inefficient solar radiation management.

When reference to “light” is made in the description of the present invention, it should be construed to include solar radiation in the spectral range of visible light, approximately 380 nm to 780 nm, based on eye sensitivity. Solar radiation is meant to include the entire spectrum including visible light and electromagnetic radiation below and/or above the spectral range of visible light.

The panel systems of the present invention are referred to as being transparent/translucent. It is intended to mean by this that the panels used in the panel systems range from transparent (transmitting light so that objects on one side may be distinctly seen from the other side) through translucent (letting light pass but diffusing it so that objects on one side cannot be clearly distinguished from the other side). Also, the panels may be tinted. Typical tinting colors include white, bronze, green, blue, and gray, although other colors may be used. Further, the panels may have a matte finish. In one embodiment combinations of different top and bottom panels may be used, such as clear/clear, white/clear, clear/white, bronze/clear, green/clear, green/white, bronze/white, white/white, etc. Also the panel system may include silica aerogel fillers (for example Nanogel® aerogel available from Cabot Corporation) in their interior since these fillers have thermal and solar performance characteristics that will enhance the performance of the invention. Finally, the panels may be of a honeycomb or other expanded form or they may be solid sheets.

The panel systems of the present invention are referred to as having selective solar control properties which means that they are fitted with selective solar control members or surfaces that themselves provide, as desired, selective solar radiation and light transmittance, as well as enhanced reflection, transmittance or absorption of solar radiation and other spectral properties. As explained in detail below, these selective solar control surfaces are provided on rotary light control members which can vary the position of the selective solar control surfaces relative to the sun, greatly enhancing the effectiveness of the selective solar control surfaces. These enhanced selective solar control properties make it possible, inter alia, to achieve improved heat rejection in summer and improved heat retention in winter, while passing, blocking, or partially transmitting visible light and avoiding excessive glare to a degree not heretofore thought possible.

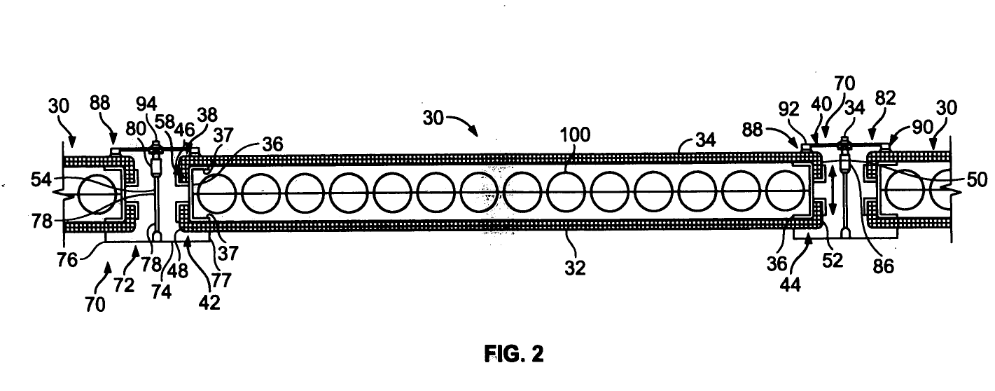

Turning now to FIG. 2, a panel system unit 30 in accordance with the invention is shown consisting of two generally flat transparent/translucent panels, including an interior panel 32 and an exterior panel 34. Panels 32 and 34 are generally parallel and are separated a distance “x” by elongated spacer rails 36 with top and bottom ledges 37 which extend along the lateral edges 38, 40, 42 and 44 of the interior and exterior panels. This spacing may be of any desired size. While panels 32 and 34 may be of any desired width, currently preferred widths are 24, 48 and 60 inches. Also, while the panels may also be any desired length, it is currently intended that panels about 2 feet to 60 feet in length will be used. Also, while less preferred, the present system may be constructed without bottom panels so long as means are provided for supporting the light controlling members as described below.

The lateral edges of the panels may be provided with respective panel joining flanges 46, 48, 50 and 52 for conveniently assembling the panels together. In one such panel-joining arrangement, the flanges each have a smooth outer face 54 and an inner face 56 with tooth-like detents 58. A similar joining flange structure is described, for example, in U.S. Pat. No. Re. 36,976, the contents of which are incorporated herein by reference. Also, panels with different panel joining flange designs and other panel-joining arrangements may be used.

An alternate panel-joining arrangement is depicted in FIG. 2A. In this embodiment, internal and external panels 32a and 34b may be made of any appropriate sheet material. The sheets are held together in this embodiment by retainers 36a which extend along the opposite lateral edges of the sheets. Retainers 36a include two channels 38 and 40 in which the lateral edges of the sheets snugly rest and a spacer 42 carrying the flanges at the desired sheet spacing of the panel system. The retainers preferably are made of aluminum or of another material that either inherently resists corrosion or is treated to resist corrosion.

A series of elongated rotatably mounted light-controlling members 100, usually corresponding in length to the length of the panel units, are disposed between panels 32 and 34 (and panels 32b and 34b). As described below, the light-controlling members may be of a variety of different structures. In a preferred embodiment, the light-controlling members will have a circular outer rotation surface extending at least about 180 degrees about their circumference. For example, elongated tubes or a series of outer annular members disposed along the light-controlling members generally perpendicularly to the longitudinal axes of the light-controlling members can be used.

FIG. 2B shows another panel system unit design 200 in accordance with the invention. In this design, interior panel 202 and exterior panel 204 enclose a series of rotary light-controlling members 100 (only the first of the series of light-controlling members is shown) which rest on the inner surface of the interior panel. Additionally, a slippery surface member consisting of a sheet of Teflon, or a different type of low-friction material or coating can be positioned at 220 between the tubes and the surface of the interior panel to minimize wear between the outer surface of the light-controlling members and the surface of the interior panel.

The interior and exterior panels are affixed in placed by a “H” connector 206 which receives abutting upstanding toothed seams 208 of the panels. The H connector includes flanges 210 along its opposite sides. As shown, the light controlling members abut the downwardly directed walls 212 of these flanges and a series of I-beam members 214 are spaced along the horizontal portions 216 of the flange to maintain the spacing between the exterior panel 204 and the light-controlling members. It is noteworthy that this structure does not require lower cross members as in the '578 patent discussed above. Rather, on the left, the light-controlling members are confined by the bottom portion 218 of the I-beams, the abutting light-controlling members and the surface of the interior panel and on the right the light-controlling members are confined by a flat member 215, the abutting light-controlling members and the surface of the interior panel.

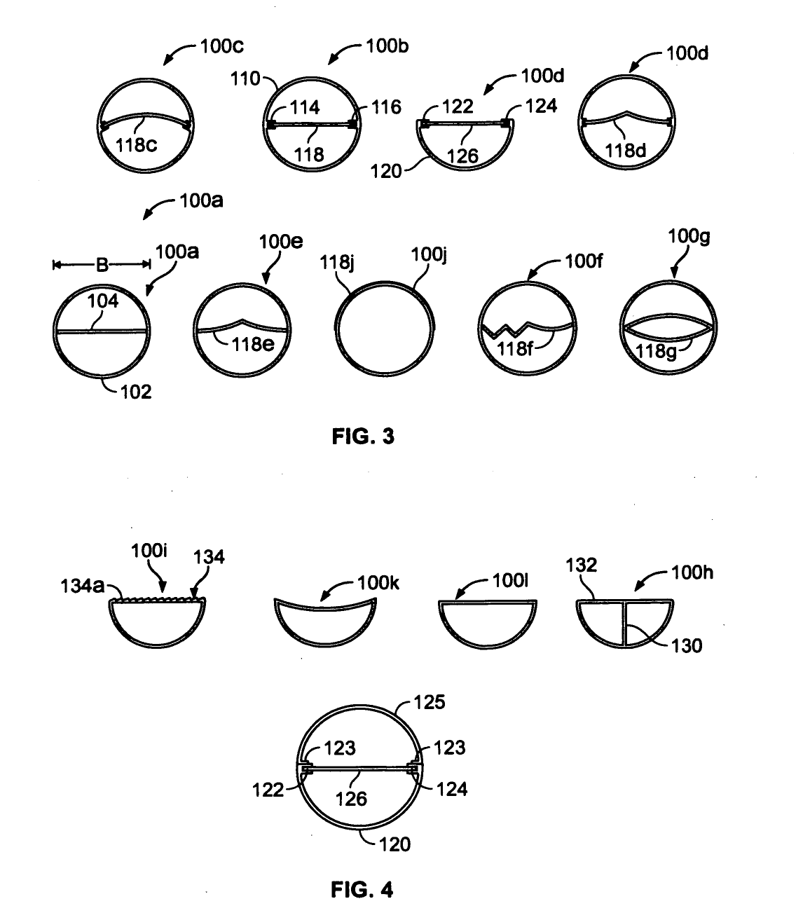

Alternative designs of the light-controlling members 100 are illustrated in cross-section in FIG. 3. For example, a light-controlling member 100a may be used, comprising a generally elongated transparent or translucent tube 102 having an outer diameter “B”. A generally planar solar-controlling member 104 is positioned in the tube across its diameter, for example, by extruding the solar-controlling member or by inserting or attaching the solar-controlling member in a preformed tube or laminating a solar-controlling member to one or both sides of a preformed member extending across the tube diameter.

Light-controlling member 100b comprises a tube 110 with a pair of opposing slots 114 and 116 formed at the inside diameter of the tube to receive solar-controlling portion 118 which is assembled into the tube after it is formed. Solar-controlling portions with different shapes can be used (such as 118c, 118d, 118e, 118f and 118g of light controlling members 100c-100g or other desired shapes). The shapes of position 100f, in particular, will achieve solar control by retro-reflection as explained below. The shapes of portions 100c, 100d, 100e and 100k will also achieve retro-reflective solar control. Also, fire resistant materials such as metal reflectors may be used as the solar-controlling portion to improve the fire resistance of the panel system. Additionally, different colors and designs may be applied to the solar-controlling portion to increase the visual interest of the panel system as the light-controlling member moves into the closed position. Indeed, the opposite sides of individual solar-controlling portions may be differently colored or bear different designs to produce different visual effects by rotating the light-controlling members 100 from one position to another.

Light-controlling member 100h of FIG. 3 comprises a solar-controlling portion 132 with a reinforcing rib 130, together forming an elongated light-controlling member with a “T” shaped cross-section, as shown. The reinforcing rib adds rigidity to the light-controlling member. Additional reinforcement may be provided by differently configured supporting walls.

Turning now to FIG. 4, Light-controlling member 100i with a generally hemispherical cross-section includes a solar-controlling surface 134 with microprism deflectors 134a (discussed below). Light -controlling member 100j (also of a generally hemispherical cross-section includes a co-extruded painted or laminated solar-controlling reflective layer 118j. Other tube configurations are illustrated in U.S. Pat. No. 6,499,255, and are incorporated herein by reference.

Another light-controlling member design designated 100k is shown in FIG. 4. This member has a generally hemispherical cross-section and preferably its circumference extends to at least about 180 degrees. Although a solar controlling surface may be co-extruded across the diameter of the tube in the illustrated embodiment the tube 120 includes a pair of opposing slots 122 and 124 at the inside diameter of the tube to receive a solar-controlling portion 126 which is assembled into the tube after it is formed. When this structure is used, a series of annular members or rings may be disposed along the length of the light-controlling member to permit complete rotation of the light-controlling member. In another alternative embodiment, once the solar-controlling portion is assembled into opposing slots 122 and 124, another tube 125 with a generally hemispherical cross-section may be assembled to tube 120 (e.g., by creating an adhesive bond or a clip-on type connection 123) to produce a complete 360 degrees tubular configuration.

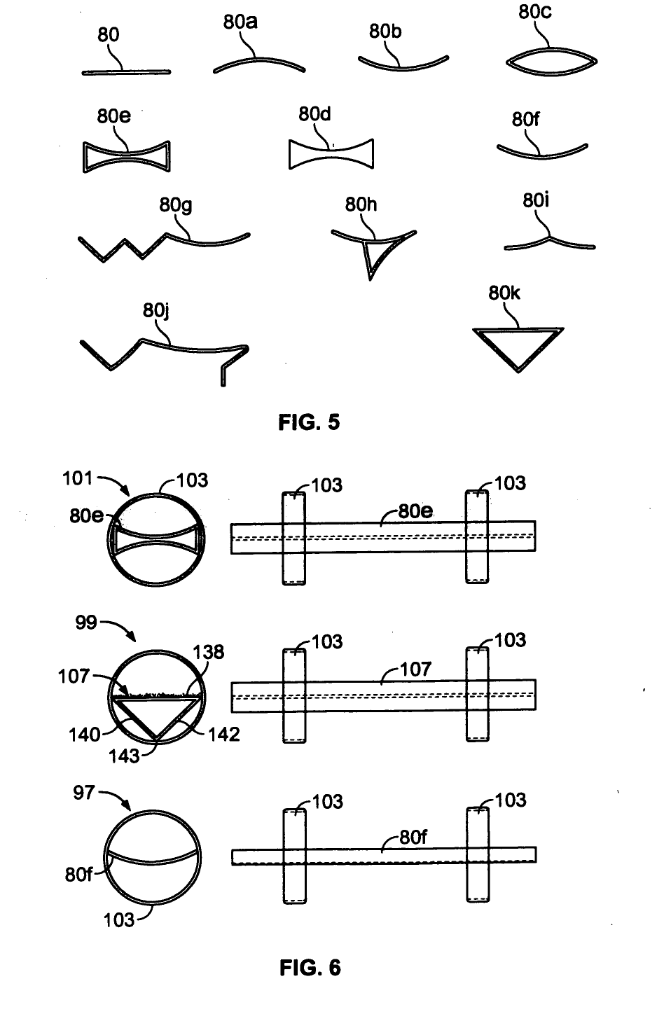

As shown in FIG. 5, the solar-controlling portion of the light-controlling member need not be flat as at 80 but may, for example, be concave or convex (80a, 80b) or have other geometrical configurations or other shapes as shown in this figure (80c-80j). These shapes employ the principle of retro-reflection (as discussed below).

Finally, tube 102 may be replaced by a series of annular members or rings 103, spaced along a light-controlling member 105, 107, 109 as shown in FIG. 6, carrying a selective solar control member. In this embodiment, the solar-controlling member should be sufficiently rigid so that applying rotary movement to the solar-control member at any point along its length will cause the entire light-controlling or solar-controlling member to rotate about its longitudinal axis without causing the members to twist substantially out of their initial configuration. Light-controlling member 99, for example, includes a series of annular members rings 103 and a solar-controlling portion 138 as well as supporting walls 140 and 142 that extend along the length of the tube and abut the rings at their apex 143. Any of the solar-controlling shapes illustrated in FIG. 5 may be equipped with an annular members or rings as described. See, for example, light controlling members 97 and 101 of FIG. 6.

In one embodiment the light-controlling members have at least one substantially solar-controlling surface wherein the visible energy is reflected and infrared energy is transmitted through the light controlling member (“cold mirror”). Such a cold mirror solar-controlling surface may be achieved by coating or extrusion techniques. Coating can be performed using vacuum deposition or other methods known in the industry for the construction of cold mirrors. Extrusion can be performed by extrusion of a filter layer with selective spectral transmittance properties. Special plastic materials such as acrylic or polycarbonate are available for this application such as 2711IRT, supplied by Spartech Polycast Company, at 70 Carlisle Place, Stamford, Conn. 06902 which has transmission properties generally as depicted in the transmission vs. wavelength graph of FIG. 11. As shown there, light-controlling members with solar-controlling surfaces made of this material will reflect visible light in the range of about 380 nm-780 nm (or portions of this range) and will transmit solar radiation about 780 nm.

In another embodiment the light controlling members and/or one or both of the glazing panels will be fitted with solar-controlling members having surfaces reflecting infrared energy and transmitting visible light (“hot mirrors”). When such hot mirror surfaces are used, the amount of heat transferred through the panel is limited and the interior space illuminated while being kept cool, thus reducing the air conditioning demand, and saving electrical power. A light controlling member with a hot mirror surface can transmit light (from a maximum transmission of at least about 85% to a minimum transmission of about 1%) in the spectral range of about 380 nm-780 nm (or portions of this range) and can reflect radiation with wavelengths greater than about 780 nm. In some cases the reflected radiation will be in the range of about 750 nm-1100 nm. This type of light control can be achieved by using a hot mirror as the solar-controlling portion, or by coating the solar-controlling in a known way to achieve the desired transmission-reflection curve is achieved. In many cases the coating will be multi-layer optical coatings prepared by deposition, dipping, spraying or other known techniques. Extrusion technology is also a viable option whereby a filter layer with selective spectral transmittance is co-extruded. Another option is a “UV hot mirror” that reflects UV and IR radiation while transmitting the visible range (or portions of this range).

In yet another embodiment the light controlling members and/or one or both of the glazing panels may have at least one substantially solar-controlling portion that blocks UV light while transmitting visible light. This can be achieved by using a UV dichroic filter that blocks radiation with wavelengths shorter than about 400 nm and transmits visible light. In another embodiment the solar-controlling portion transmits the UV radiation while reflecting the visible light and/or the IR radiation. In another preferred embodiment the solar controlling portion absorbs UV radiation while reflecting light and infrared radiation.

“Retro-reflective” materials are materials that at least in part reflect light back towards a desired direction. The optical and visual behavior of retro-reflection can be described using luminous intensity distribution curves corresponding to differing reflection at differing orientations of the retro-reflective surfaces to incoming light or radiation. Thus, the retro-reflective surfaces can control or direct light directed into the interior of architectural structures by retro-reflecting it towards the interior of the structure as well as mirroring or reflecting it towards the exterior. Retro-reflection may use geometrical shapes that provide directionally selective reflection surfaces with dual functions: one component or series of components retro-reflects incident solar radiation; and the other component or series of components deflects diffused light into the interior space.

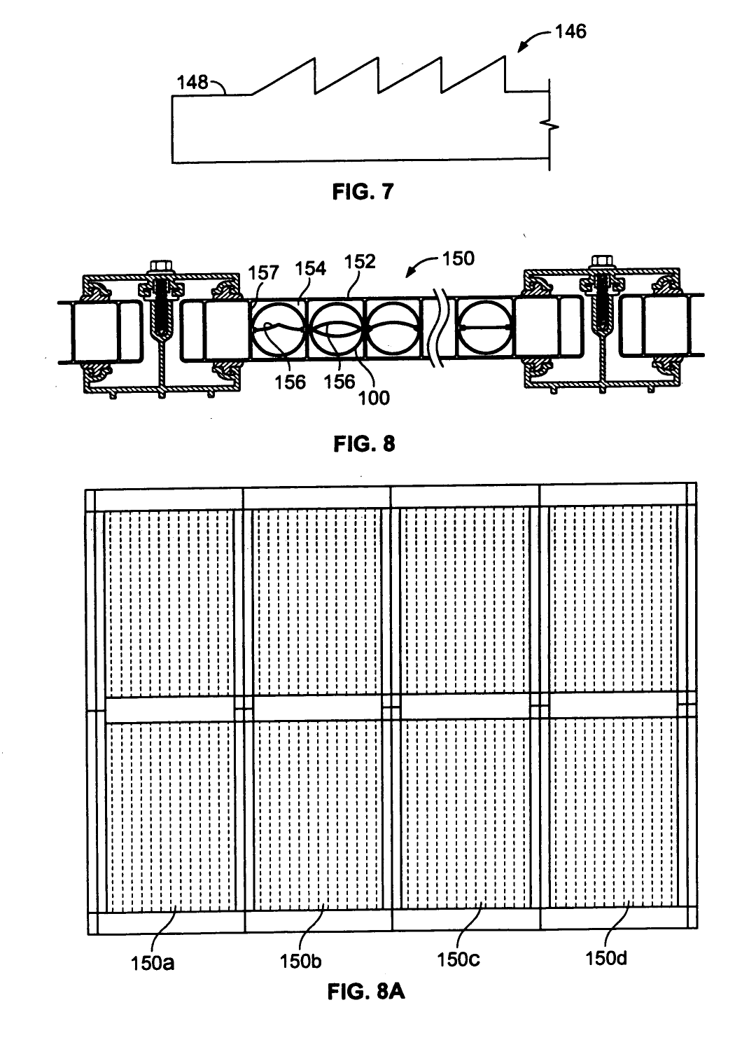

As illustrated in FIG. 7, for example, micro-prismatic toothing 146 on the surface 148 may be used for retro-reflection either alone or on a geometric retro-reflective surface. Such micro-prismatic toothing is carefully calculated to achieve the desired results thus avoiding overheating and glare. This micro-structured mirroring may be rolled onto an aluminum substrate. Subsequently may be glossed, anodized and formed into a geometrical shape.

In one design the retro-reflection louver is constructed in two sections: the first section is retro-reflecting and the second section is designed as a “light shelf”. The top sides facing the sun are mirrored. Solar protection is provided by the first section, which can block overheating rays. The second section deflects light towards the interior. Since heat emission into the interior of the building is a factor for thermal comfort in the summer, light-controlling members using retro-reflective surfaces can reduce heat radiation and improve thermal comfort. Retro-reflection blocks direct sunlight by reflection preventing undesirable heating effects in summer.

In one embodiment, the light-controlling member allows transmission and/or blocking of the sunlight into the interior space, while reflecting light from the interior space back into the interior. An artificial light also may be projected onto the interior surface of the glazing panels with the intention that this light will be reflected and/or diffused back into the interior space. Also, the light-controlling member can be designed in such a way that when rotated in at least one angular position it will block the passage of radiation through the panel substantially more effectively than achieved in the approach of the '255 patent, overcoming the shortcoming of the '255 patent with regard to the minimum light transmission through the panel.

In yet another embodiment the light controlling members have smooth or micro-prismatic reflective surfaces. Using reflective surfaces allows a wide range of light control including full reflection of incoming light. For example, the reflective surfaces may be oriented so that light will be reflected from the brightest parts of the sky to the interior of the structure, enhancing the total amount of light transmitted to the interior. Total light enhancement can be also achieved by positioning micro optical prisms on the selective solar control surface to tunnel more light into the interior space. Reflectors can be made of extruded and polished aluminum in the desired shapes or extruded plastic with co-extrusion of a reflective layer. Also, roll-forming of polished metal may be used.

Turning now to FIG. 8, a panel system unit 150 in accordance with the invention is shown consisting of extruded twin-wall transparent/translucent plastic members 152, including a series of rotatably mounted light-controlling members 100 positioned in a series of adjacent cells 154 separated by walls 157. Light-controlling members 100 have solar-controlling members 156 (shown in varying shapes for purposes of illustration). Thus, in the illustrated embodiment, solar rays strike the varying geometries of the surfaces of the solar-controlling members 156 to deflect solar transmission in different ways. Since these solar control surfaces can be rotated, a very broad range of light and radiation control can be achieved. A series of panels 150, may be joined together as shown with weather-tight glazing bar 158 and clamping bar 160.

A series of panel units assembled to produce a panel system for use in a skylight is illustrated in FIG. 8A. In this fully assembled system, the panel units 150a, 150b, 150c, and 150d are each individually assembled and joined to adjacent panel units as illustrated in this figure and described above.

A wide variety of different types of glazing panels made of various transparent and translucent materials may be used, including, but not limited to, plastics (including polycarbonates and acrylics), fiberglass, perforated metal fabric, or glass. It is preferred, however, that the panels have at least the appropriate light transmitting properties and a minimum resistance to impact of about 20 ft/lb. Also, a UV-resistant layer can be co-extruded with the panel to minimize the need for periodic resurfacing. Also a Fiberglass Sandwich Panel may be used as manufactured by Kalwall Corporation of New Hampshire or the like. These panels comprise two fiberglass skins attached to an internal grid core. Such Kalwall panels may be viewed at www.kalwall.com.

The light-controlling members may have reflectance to a level which produces the desired degree of light transmission. Also, the light-controlling members may be segmented, for example into reflective portions, and/or transparent/translucent portions. For example, in a 40-foot panel unit with corresponding 40-foot light-controlling members, the first 10 feet of one or more of each of the light-blocking members may carry a mirrored surface of the geometry of 80g of FIG. 5, the next 5 feet can be transparent/translucent and carry a UV dichroic filter, and the last 25 feet may carry the mirror surface of the geometry of 80g of FIG. 5. Such a segmented arrangement can be used where it is desired to maintain a lighted area at all times or to create special lighting effects.

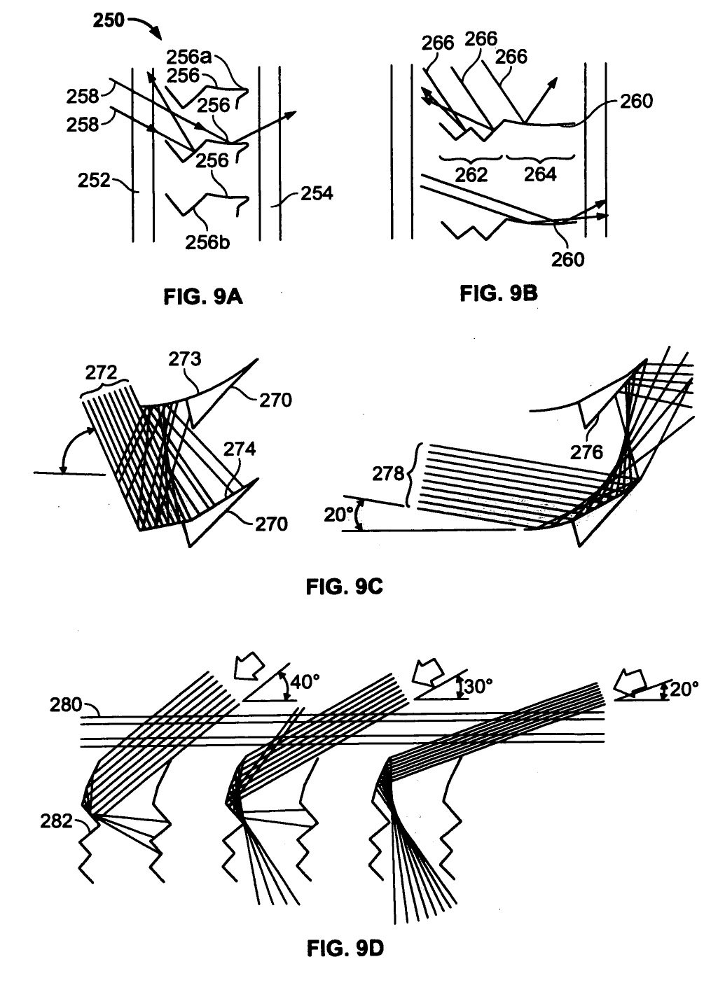

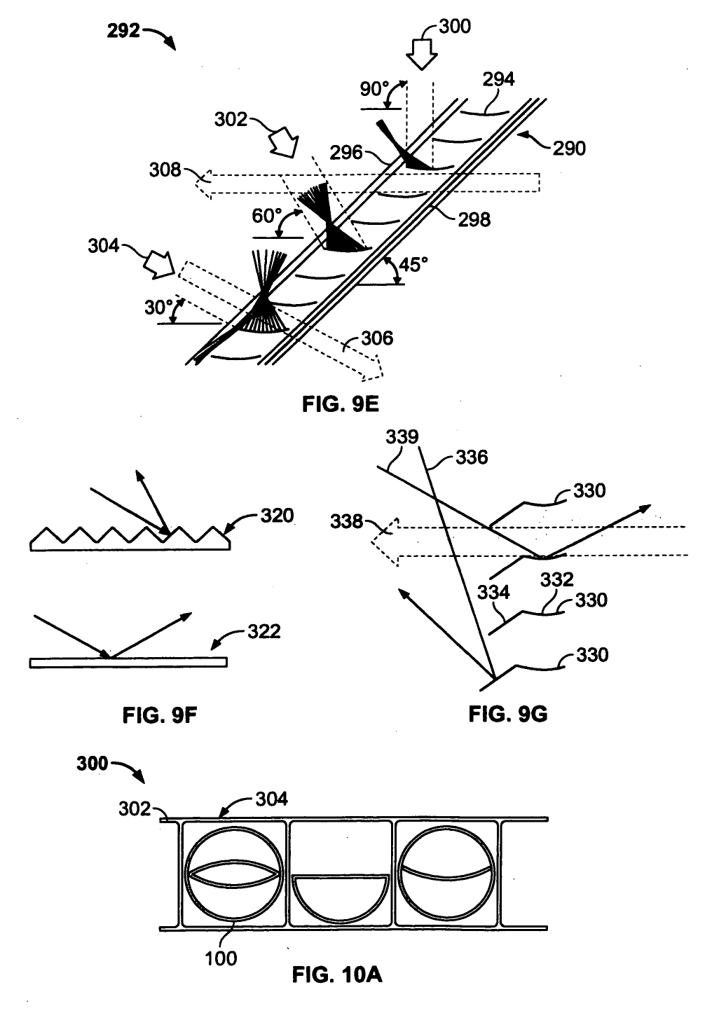

We turn now to FIGS. 9A-9G to describe various preferred retro-reflective assemblies in accordance with the invention. Thus, FIG. 9A shows a panel unit 250 installed in a vertical surface of a structure. Panel unit 250 includes an outer glazing panel 252 and an inner glazing panel 254. A series of selective solar-control members 256 (see 80j of FIG. 5) are oriented one above the other between the two glazing panels. Although not shown, each of these selective solar control members is mounted in a rotary light-controlling member, as discussed earlier. Each of the selective solar control members includes a generally horizontal reflective surface 256a and an angled surface oriented at an angle less than 180 degrees to the generally horizontal surface [reflective] 256b. Incoming solar radiation is labeled 258 and passes through outer glazing panel 252. Some of this radiation strikes the horizontal reflective surface and is reflected into the interior of the structure. A portion of the light, however, strikes the angled reflective surface 256b and is reflected back out of the outer glazing panel. Rotation of the solar selective members will change the quantity of light which is either reflected back out or reflected into the interior of the structure, as desired.

FIG. 9 shows another retro-reflective surface 260. Retro-reflective surface 260 includes a saw-tooth portion 262 and a clod------portion 264. Light rays 266 coming in at a high elevation (and thus corresponding to bright high-energy warming sunlight) is shown striking the saw tooth portion and being reflected back out of the glazing panel. The light ray which is shown striking the curved portion 260 is reflected upwardly close to the vertical and will strike the bottom of the next retro-reflective member (not shown) and therefore become diffused lighting. Light rays 268 coming in at a much lower elevation (and thus less intense and warming) are shown striking the curved portion and passing through the inside panel length. Some of these low elevation rays will, of course, hit the saw-tooth portion and be reflected back out. Again, the retro-reflective solar controlling members 260 will be rotated in the practice of the present invention thereby enabling wide-ranging solar controlling.

FIG.9C shows yet another retro-reflective solar-controlling member 270 and light rays 272 incoming at about 55 degrees to the horizontal. As can be seen here, these high elevation, high energy rays are reflected off of the curved surface 272 of the lower retro-reflective member and blocked by the bottom of the upper retro-reflective member, so that virtually none of this light escapes past the retro-reflective members. In the lower portion of FIG. 9C, however, sunlight 274 is coming in at an angle of about 20 degrees to the horizontal (is thus far less intense than light 272) and is reflected up off of curved surface 272, where it engages the inwardly directed generally flat surface 274 of the upper retro-reflective member which in turn directs this radiation into the interior of the structure.

FIG. 9D shows a glazing panel 280 in the roof of a structure (not shown). The retro-reflective members 282 in this figure correspond generally to those of FIG. 9B, but are oriented generally vertically. Thus, it is seen that when light is coming in at about 40 degrees to the horizontal, it is reflected in such a way that it is generally trapped or dispersed between the two retro-reflective members. When the light is coming in at about 30 degrees to the horizontal, a substantial portion is reflected between the two retro-reflective members and enters the structure. Finally, when the light is coming in at about 20 degrees to the horizontal, a far greater portion of the light is reflected into the interior of the structure.

FIG. 9E shows an angled roof 290 having a series of curved retro-reflective members 294 disposed between outer and inner glazing members 296 and 298. These retro-reflective members are mounted for rotary motion on light-controlling members as described above. Also, at least the top surfaces of the retro-reflective members have a microprismatic surface. Thus, it is seen in this figure that light 300 entering at 90 degrees to the horizontal is reflected up and away from the interior of the structure by the combination of the curved surface of the retro-reflective member and the microprismatic surface. Light 302 coming in at about 60 degrees to the horizontal similarly deflected away. However, light 304 coming in at about 30 degrees to the horizontal is reflected upwardly by the microprismatic surface where it strikes the bottom microprismatic surface of the retro-reflective member and a portion is directly transmitted at 306 to the interior of the structure. It is apparent, as the angle falls, more and more light will be directed into the interior of the structure. Also, this arrangement permits direct visual contact with the outside through, for example, site line 308. Since members 294 are mounted in rotatable light-controlling members, a very broad range of control of incoming and outwardly deflected light can be achieved.

A microprismatic surface 320 is shown in FIG.9F juxtaposed next to a conventional mirror. Thus, as can be seen in this figure, unlike a conventional mirror where the angle of reflection of incoming light equals the angle of incidence, with such a microprismatic reflective surface, incoming light is generally returned to the direction from which it came.

Finally, in this FIG.9G, a series of retro-reflective members 330 are shown. Each of these members includes a generally horizontally directed curved surface 332 and a generally downwardly directed curved surface 334. Thus, light rays 336 coming in at a relatively low angle are reflected into the interior of the surface structure by surface 332. However, light rays 336 coming in a high elevation are reflected away from the interior of the structure by light surface 334. Also, these retro-reflective members permit a line of sight along 338.

While FIGS. 9A-9G contains diagrammatic representations of solar controlling portion using the principle of retro-reflectivity, other configurations and designs are described in “Dynamic Daylighting Architecture Basics, Systems, Projects” by Dr.-Ing. Helmut Koster and are incorporated by reference.

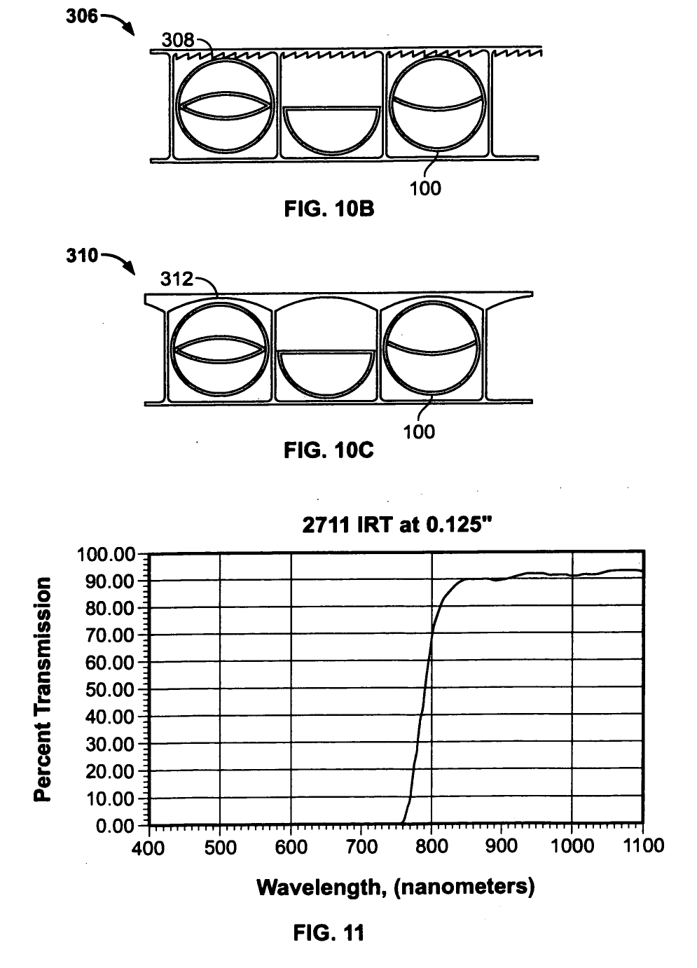

FIG. 10A illustrates an extruded panel 300 wherein the exterior 302 is covered by a co-extruded filter layer/layers 304, that selectively reflects a portion of the IR and/or UV radiation.

FIG. 10B illustrates an extruded panel 306, where the top 303 of the panel which deflects solar radiation as described for example in connection with FIG. 9F. FIG. 10C illustrates an extruded panel 310 where the surface of the top panel above each of the rotatable light-controlling members 312 is a curved surface.

In each of the embodiments of this invention, the light-controlling member may include photovoltaic solar cells to generate electricity, preferably in conjunction with means for maximizing the photovoltaic output by rotating the light-controlling members with movement of the sun across the sky to insure that the photovoltaic solar cells continuously receive the maximum possible sunlight exposure.

Any methods may be used for rotating the light-controlling members where rotary motion is imparted to one or more of the adjacent light-controlling members either manually or by motorized means. Any of the mechanisms described in U.S. Pat. No. 6,499,255, for example, may be used for imparting such rotary motion.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for controlling solar radiation passing through a glazing panel comprising:
a rotatable light controlling member positioned below the glazing panel; and
selective solar control means associated with the rotatable member for selectively controlling the solar radiation passing through the panel.

2. The apparatus of claim 1 which the rotatable member is positioned between two generally parallel glazing panels.

3. The apparatus of claim 2 in which the rotatable member rests on one of the glazing panels and the other glazing panel is supported by at least one cross-member.

4. The apparatus of claim 1 in which the light-controlling member has a circular outer rotation surface extending at least about 180 degrees about its circumference.

5. The apparatus of claim 1 in which the rotatable member comprises an elongated tube.

6. The apparatus of claim 1 in which the rotatable member comprises a series of annular rings disposed generally perpendicularly to its longitudinal axis.

7. The apparatus of claim 1 in which the light-controlling members is a generally elongated transparent or translucent tube and the selective solar control mean is disposed across the diameter of the tube.

8. The apparatus of claim 1 in which the rotatable member is an elongated generally hemispherical tube and the selective solar control means is disposed along the flat surface thereof.

9. That apparatus of claim 1 in which the solar control means is curved.

10. The apparatus of claim 1 in which the selective solar control means is a cold mirror.

11. The apparatus of claim 1 in which the selective solar control means is a hot mirror.

12. The apparatus of claim 1 in which the solar control means blocks UV radiation while transmitting visible light.

13. The apparatus of claim 1 in which the selective solar control means transmits UV radiation while reflecting visible light and/or infrared radiation.

14. The apparatus of claim 1 in which the selective solar control means absorbs UV radiation while reflecting visible light and infrared radiation.

15. The apparatus of claim 1 in which the selective solar control means is a retro-reflective member.

16. The apparatus of claim 15 in which the retro-reflective member carries micro-optical prisms on its surfaces.

17. The apparatus of claim 1 in which the selective solar control means comprises microprismatic mirrors.

18. The apparatus of claim 1 in which the selective solar control means is segmented into portions that selectively control light and/or solar radiation in differing ways.

19. The apparatus of claim 1 in which the selective solar control means comprises a coating on the rotatable member.

20. The apparatus of claim 19 in which the coating selectively reflects a portion of the infrared radiation spectrum.

21. The apparatus of claim 1 in which the light controlling member includes a photovoltaic solar cell that, with the movement of the rotatable members, follows the movement of the sun across the sky to maximize its output.

22. A method for controlling light and/or solar radiation passing through a glazing panel comprising:
providing a rotatable light-controlling member positioned below a glazing member, the rotatable member having a selective solar control member associated therewith; and
rotating the rotatable member to vary the orientation of the selective solar control member.

23. The apparatus of claim 1 in which the glazing panel includes a selective solar controlling layer.

24. A panel of controllable solar radiation transmissivity comprising:
a plurality of rotatable light controlling members, each of the members being adapted for selectively controlling solar radiation; and
means for rotating the light controlling members, the members when rotated being adapted to vary the passage of solar radiation through the panel,
characterized by a plurality of substantially transparent tubular cells, the light controlling members being mounted for rotation in at least some of the tubular cells.
